(19) United States
(12) Patent Application Publication
(10) Pub. No.: US 2006/0272124 A1
(43) Pub. Date: Dec. 7, 2006

(54) Control assembly for a door closer

(76) Inventor: George Wartian, Mt. Clemens, MI (US)

Correspondence Address: MATTHEW J. SCHMIDT, P.O. BOX 4390, TROY, MI, 48099, US

(21) Appl. No.: 11/144,306

(22) Filed: Jun. 3, 2005

(51) Int. Cl. E05F 3/02

(52) U.S. Cl. 16/66

(57) ABSTRACT

A control assembly for use with a door closer on a swinging door. The control assembly has a housing adjacent to the door closer, a clip having an actuating and a locking tab, and a biasing member that yieldably biases the clip to a released position. The actuating tab can be actuated from outside of the housing to engage the locking tab with part of the door closer to maintain the position of the door. The locking tab can automatically be released from the door closer by further opening the door whereupon the biasing member returns the clip to its released position so that the door may close.

### FIELD OF THE INVENTION

This invention relates generally to door closers for doors, and more particularly to a control assembly that releasably holds a door open.

### BACKGROUND OF THE INVENTION

Swinging doors, such as screen or storm doors and the like, are common in residential homes. They can provide an additional and sometimes convenient closure for doorways in garages, in side entries, and the like. Typically, a door closer is mounted on such a door to assist its opening and closing movements. These door closers ordinarily have a cylinder with a rod extending through one of its ends and a piston carried by the rod inside the cylinder.

Occasionally it is desired to keep swinging doors briefly open—as when bringing groceries or other objects into the house. And so control assemblies have been developed for this purpose. Most include a clip disposed outside of and entirely separate from the cylinder on the door closer rod that, when cocked, stops the rod travel into the cylinder and keeps the door open. When not in use, the clip must be disposed away from the cylinder to avoid interfering with the ordinary closing of the door. To hold the door open, the clip must manually be slid along the rod which usually is dirty, and this task can be cumbersome. Some control assemblies are of relatively complex design and construction that can increase costs. And still others are designed for a specific door closer and thus have limited use.

### SUMMARY OF THE INVENTION

A control assembly for a door closer having a cylinder and a rod includes a housing preferably disposed adjacent to the cylinder, a clip having an actuating tab accessible from outside the housing, and a locking tab releasably engageable with the rod. The clip is moveable between a released position where the actuating tab generally lies in a plane that is parallel to a door closer axis and a holding position where the actuating tab generally lies in a plane that intersects the door closer axis. Further, the assembly comprises a biasing member yieldably biasing the clip to its released position.

In another implementation, a door closer assembly has a control assembly to releasably keep a door open. The door closer assembly includes a door closer having a cylinder, a rod extending through an end of the cylinder, and a piston carried by the rod in the cylinder. The assembly also includes a housing disposed adjacent to the rod, and a clip carried by the housing. The clip has an actuating tab accessible from outside the housing and extending generally parallel to the rod, and a locking tab disposed inside the housing to releasably engage the rod and keep the position of the rod when the clip is moved from a released position to a holding position. Further, the assembly comprises a biasing member yieldably biasing the clip to its released position.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a front view of a portion of a door and one presently preferred embodiment of a control assembly and a door closer that is partly broken away to show some of its internal components.;

FIG. 1A is enlarged view of the encircled portion 1A in FIG. 1;

FIG. 2 is a front perspective view of a housing of the control assembly of FIG. 1;

FIG. 3 is a rear perspective view of the housing of FIG. 2;

FIG. 4 is a perspective view of a clip of the control assembly of FIG. 1;

FIG. 5 is a cross-sectional view of the control assembly of FIG. 1 shown in a released position; and

FIG. 6 is a cross-sectional view of the control assembly of FIG. 1 shown in a holding position.

### DETAILED DESCRIPTION OF PREFERRED EMBODIMENTS

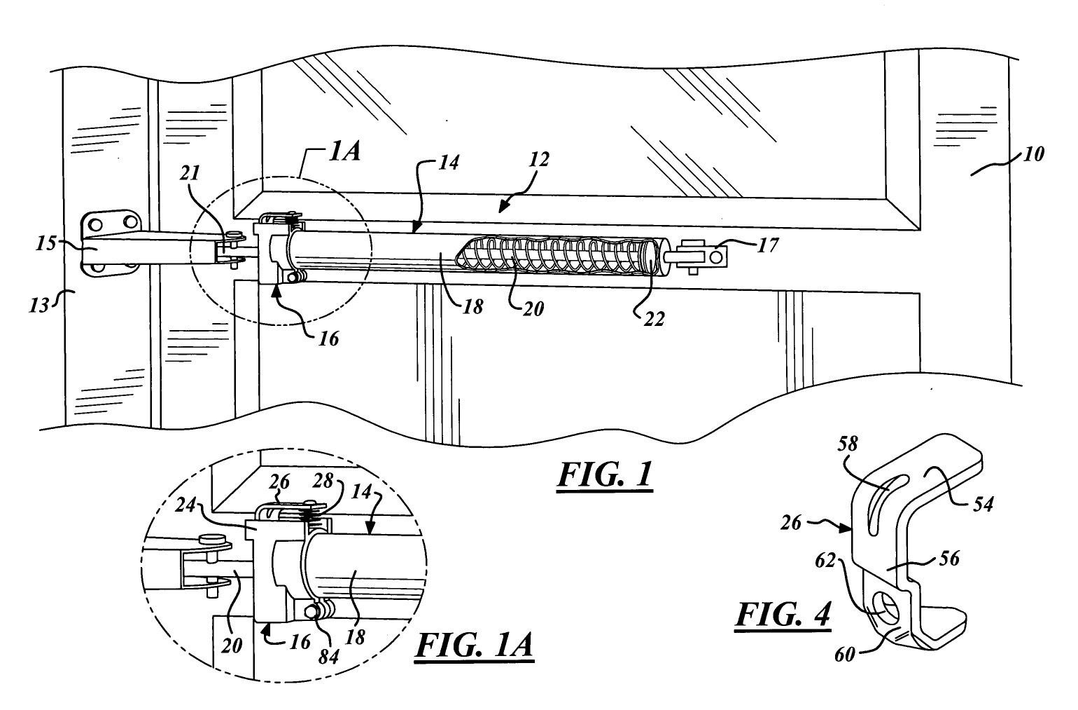

Referring in more detail to the drawings, FIG. 1 shows a door 10 such as a swinging door, like screen or storm doors and the like. A door closer assembly 12 is installed on the door 10 to control its swinging movement when it is opened and closed. The closer assembly 12 preferably is located adjacent to the bottom of the door 10 in conventional manner. Specifically it is connected at one end to a door frame 13 and at its other end to the front of the door itself, such as by brackets 15, 17, respectively. Among other components, assembly 12 includes a door closer 14 and a control assembly 16 that together, and separately, control the movement of door 10.

Door closer 14 controls the movement of door 10 between its open and closed positions. The closer 14 may be of conventional construction and may generally operate in a known manner. In brief, the closer 14 has a cylinder 18 connected to the door, a rod 20 that extends out of the cylinder to an end 21 that is pivotally coupled to the bracket 15 attached to a wall, and a piston 22 that is carried by the rod for axial reciprocation inside the cylinder. The partly broken away view of FIG. 1 shows these components as they are positioned when the door is closed. As is known, together these components provide door closer 14 with an air compression feature that allows door 10 to be swung open and to close in a controlled manner. Other constructions and arrangements can be used, for example, the rod 20 could be connected to the door 10 and the cylinder to a wall.

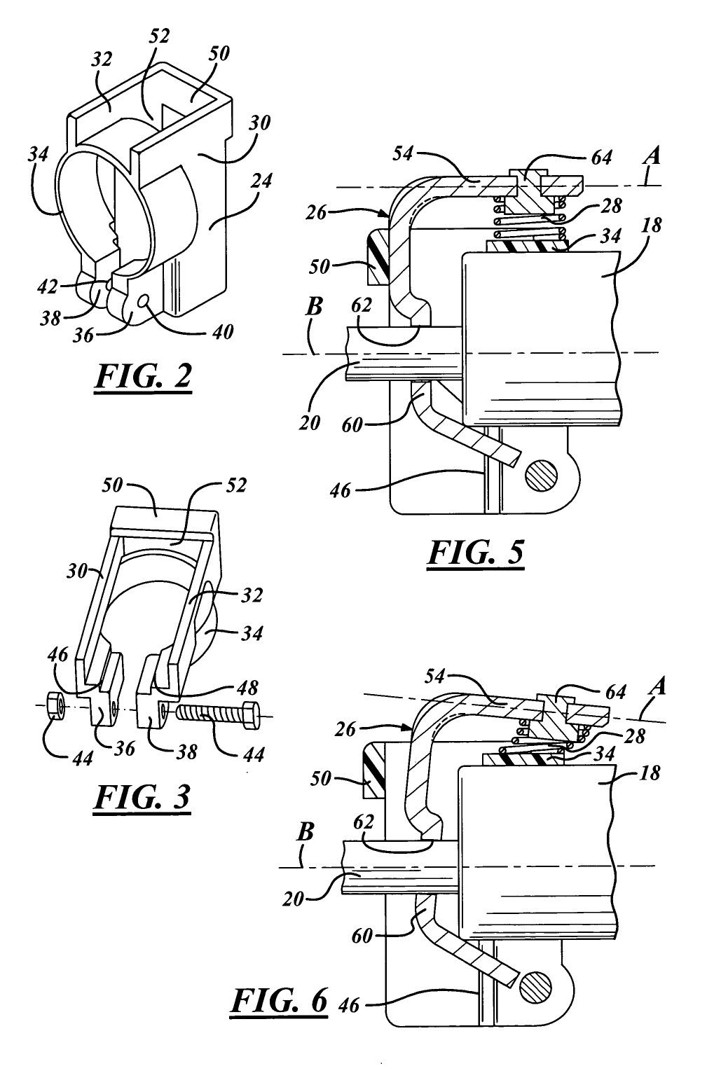

Control assembly 16 is used with door closer 14 to releasably keep the door 10 open when desired. As best shown in FIGS. 1A, 2 and 3, the control assembly 16 preferably includes a housing 24 that is mounted or carried on an end of cylinder 18, a clip 26 selectably moveable into and out of engagement with the rod, and a biasing member 28 that acts on the clip 26.

The housing 24 preferably carries the clip 26, and installs the assembly 16 to the door closer 14. The housing 24 may be made from a conventional injection molding process and from any suitable material, for example, plastics or metals. The housing preferably includes side walls 30, 32, a sleeve 34, a retainer 50, and an opening 52. Although in the currently preferred form these features are formed in a unitary structure, any one or all of them can be separately made and attached or connected together.

The housing includes a sleeve 34 that preferably has a generally cylindrical inner surface disposed around an end of the cylinder. To facilitate mounting the housing on the cylinder, the cylinder is preferably split and a pair of spaced apart tabs 36, 38 are provided on either side of the split and have aligned bores adapted to receive a fastener, such as a screw 44. Accordingly, the tabs 36, 38 may be separated to increase the diameter of the inner surface and thereby facilitate disposing the inner surface around the cylinder. Thereafter, a screw 44 may be inserted through aligned bores in the tabs and a nut provided on the screw and tightened to draw the tabs closer together and clamp the sleeve about the cylinder.

The pair of side walls 30, 32 extend from the sleeve 34 and generally away from the cylinder. The side walls are generally planar, spaced apart and generally parallel to each other. At one end, the side walls preferably extend beyond the sleeve to define a recess with the sleeve, and at their other end the side walls preferably extend to the tabs 36, 38. The juncture of the side wall and tabs may have a stepped configuration providing one or more shoulders or notches 46 therein. A retainer 50 spans the side walls, and defines part of the recess and an opening 52 communicating with the recess.

The clip 26 is carried at least in part by the housing and releasably engages the rod 20 to keep the position of the rod relative to the cylinder, or arrest its motion, and thus keep the position of door 10. In this way, the clip 26 is moveable between a released position where the rod is free to move relative to the cylinder, and a holding position where the clip 26 prevents movement of the rod to keep the door open. As best shown in FIGS. 4-6, the clip 26 preferably is a generally C-shaped, thin plate. The clip can be made from any material that will give it sufficient strength and rigidity such as steel, aluminum, or other metals and various polymers or composites and the like. Its exact manufacturing method will depend on the material used but as with steel, conventional punching, cutting, and bending processes performed in various ways and order can be used to produce the one-piece structure. As mentioned, and as will be described in more detail later, the clip 26 is carried by housing 24 so that part of it remains inside the housing and part of it is exposed or accessible from outside the housing. The clip 26 may also be carried by the rod 20, and preferably includes a hole 62 through which the rod 20 slides when the clip 26 is in its released position. The clip 26 includes an actuating tab 54 and a locking tab 56 that are separated by a bend with a rib 58 therein to add strength to the bend between the tabs.

The actuating tab 54 is a generally planar rectangle that extends perpendicularly away from the locking tab 56 with the rib 58 partly formed therein. The actuating tab 54 is disposed generally in the recess and is accessible from outside the housing 24 to permit movement of the clip 26. The actuating tab 54 is preferably radially spaced from the cylinder and part of the tab preferably lies over sleeve 34.

The locking tab 56 is mostly located and disposed within housing 24 and has a tail end 60 with the hole 62 through which the rod 20 is slidably inserted. As shown in FIG. 5, part of the tail end 60 bends in a similar direction as tab 54 to provide a stop that engages the cylinder 18 to locate the clip 26 in its released position. The hole 62 has a circular shape with a slightly larger diameter than that of the rod 20 so it can form a slightly loose and sliding fit with the rod 20 when the clip 26 is in its released position.

The biasing member 28 yieldably biases clip 26 toward its released position so that the control assembly 16 remains in its released position when it is not in use. The biasing member 28 can be any device that creates a biasing force, such as a conventional coil spring, by way of example without limitation. Looking now to FIGS. 5 and 6, the biasing member 28 is generally disposed between the housing sleeve 34 and actuating tab 54 where it lies over the cylinder 18. In this position, it is partly located within housing 24 and partly exposed out of the housing. When, as shown here, a coil spring is used, a screw or rivet 64 is disposed through the actuating tab 54 to retain one end of the coil spring. At its other end the spring 28 can simply rest against the sleeve 34, can be fastened thereto or disposed over a projection (not shown) on the sleeve 34 or cylinder 18.

In use, the door closer assembly 12 is installed on a door 10 to control its opening and closing movements, and to stop the door and keep it open when desired. Door closer 14 and control assembly 16 can be installed together, or assembly 16 can be installed on an already installed closer. Assuming the latter, and looking back to FIG. 1A, the closer end is unhinged so that control assembly 16 can be placed on it. This means that rod 20 is inserted through housing sleeve 34 and then through clip opening 62, and assembly 16 is slid down rod 20 until it reaches cylinder 18. Here, the sleeve 34 is fit over and around the end of cylinder 18, and the screw and nut 44 are used to tighten and secure the sleeve 34 around the cylinder 18. The door closer can be re-hinged and the control assembly is now installed on the door closer.

Once installed, the door closer assembly 12 is ready for use. As best shown in FIG. 5, the biasing member 28 keeps the clip 26 in its released position. When the clip 26 is in this position, the rod 20 can slide through opening 62 and in and out of cylinder 18 allowing the door to move between its open and closed positions generally uninterrupted by clip 26. In this state, actuating tab 54 generally lies in a plane A that is parallel to an axis B of the cylinder 18 and rod 20. Also, clip 26 is held by retainer 50 in the area of the locking tab 56 to keep the clip 26 in place adjacent to the cylinder 18 when the door 10 is opened, as even minimal friction between the clip 26 and the rod 20 would create a tendency for the clip 26 to move with the rod 20.

To releasably retain the door 10 in an at least partially open position, the actuating tab 54 is depressed against the bias of the spring 28 which is thereby compressed. Hence, the clip 26 is cocked or canted relative to the rod 20 and frictionally engages the rod 20, as shown in FIG. 6. The frictional engagement of the clip 26 on the rod 20 prevents movement of the rod 20 relative to the clip 26. When the tab 54 initially is depressed, the clip 26 may be spaced from the cylinder 18. Even though the rod 20 is held from movement relative to the clip 26, the clip 26 and rod 20 may move together toward the cylinder 18 a short distance until the clip 26 engages the cylinder 18 and further movement of the rod 20 and clip 26 are prevented, and the door 10 is held open. The actuating tab 54 may then be released and the force of the door, which wants to close, holds the clip 26 against the cylinder 18 and the door is held open. In this state, plane A intersects and is inclined relative to the axis B of the door closer.

To release the door 10 so that it may close, the door 10 is opened at least slightly and the rod 20 is moved further out of the cylinder 18. This moves the clip 26 out of contact with the cylinder 18, and the biasing member 28 returns the clip 26 to its released position. Thus, in this implementation, the clip 26 preferably can be moved from its holding position to its released position without direct manual manipulation of the clip 26. Rather, movement of the door is sufficient to release the clip 26 and permit the door to close.

Upon reading the disclosure herein, one ordinarily skilled in the art would readily recognize embodiments other than those disclosed herein, with those embodiments being within the spirit and scope of the invention. Accordingly, the disclosure herein is intended to be exemplary, and not limiting. The scope of the invention is defined by the following claims.

1. A control assembly for a door closer, comprising:
a housing disposed adjacent to part of the door closer;
a clip having an actuating tab that can be actuated from outside the housing and a locking tab that is unitary with the actuating tab and generally located within the housing, the clip being moveable between a released position where the door can open and close, and a holding position where the door is kept open and where the locking tab is moved with the actuating tab when the clip is moved to the holding position to releasably maintain the position of the door closer; and
a biasing member yieldably biasing the clip to its released position.

2. The control assembly of claim 1 wherein the door closer has a cylinder and a rod movably lying along an axis that defines the door closer axis.

3. The control assembly of claim 1 wherein the actuating tab is generally planar, is unitary with the locking tab, and extends perpendicularly from the locking tab.

4. The control assembly of claim 2 wherein the door closer includes a cylinder in which the rod is at least partially received for reciprocation relative to the cylinder and the housing is carried by the cylinder so that the rod is moveable relative to the housing and the clip, and when in its holding position the clip bears on the cylinder or the housing and is releasably engaged with the rod to prevent movement of the rod relative to the housing.

5. The control assembly of claim 4 wherein the housing includes a split sleeve that is received around the cylinder, and a pair of tabs that when moved together reduce the size of the sleeve to facilitate clamping the sleeve on the cylinder.

6. The control assembly of claim 5 wherein the clip, when in its holding position, prevents movement of the rod relative to the clip so that the clip may be disengaged from the cylinder or housing by withdrawing the rod further from the cylinder to move the clip away from the cylinder or housing with which it was engaged.

7. The control assembly of claim 6 wherein either the rod or the cylinder is arranged for connection to a door so that movement of the door causes relative movement between the rod and the cylinder, and the clip is disengaged from the cylinder or housing when the door is moved further toward its open position whereupon the biasing member returns the clip to its released position permitting movement of the rod relative to the clip so that the door may close.

8. The control assembly of claim 4 wherein the biasing member moves the clip from its holding position to its released position when the clip is disengaged from the cylinder or housing.

9. The control assembly of claim 1 wherein the biasing member is a spring that is disposed between the housing and the actuating tab.

10. A door closer assembly having a control assembly to releasably keep a door open, comprising:
a door closer having a cylinder, a rod extending through an end of the cylinder, and a piston carried by the rod for reciprocation in the cylinder as the door is opened and closed, and either the rod or the cylinder is connected to the door;
a housing disposed adjacent to the rod;
a clip retained adjacent to the cylinder by the housing, having an actuating tab accessible from outside of the housing, and a locking tab that releasably engages the rod and the cylinder to keep the position of the rod relative to the cylinder when the clip is moved from a released position to a holding position; and
a biasing member yieldably biasing the clip to its released position.

11. The door closer assembly of claim 10 wherein, when in the released position where the door can open and close, the actuating tab generally lies in a plane that is parallel to an axis defined by the rod.

12. The door closer assembly of claim 11 wherein, when in the holding position, the actuating tab generally lies in a plane that intersects the rod axis.

13. The door closer assembly of claim 10 wherein the actuating tab partially overlies and is disposed at least partly radially spaced from the cylinder.

14. The door closer assembly of claim 10 wherein the actuating tab is generally planar and extends perpendicularly from the locking tab.

15. The door closer assembly of claim 10 wherein the housing is carried by the cylinder so that the rod is moveable relative to the housing and the clip as the door is moved between its opened and closed positions, and when in its holding position the clip bears on the cylinder or the housing and is releasably engaged with the rod to prevent movement of the rod relative to the housing.

16. The door closer assembly of claim 10 wherein the housing includes a split sleeve that is received around the cylinder, and a pair of tabs that when moved together reduce the size of the sleeve to facilitate clamping the sleeve on the cylinder.

17. The door closer assembly of claim 15 wherein the clip, when in its holding position, prevents movement of the rod relative to the clip so that the clip may be disengaged from the cylinder or housing by withdrawing the rod further from the cylinder to move the clip away from the cylinder or housing with which it was engaged.

18. The door closer assembly of claim 17 wherein movement of the door causes relative movement between the rod and the cylinder, and the clip is disengaged from the cylinder or housing when the door is moved further toward its open position whereupon the biasing member returns the clip to its released position permitting movement of the rod relative to the clip so that the door may close.

19. The door closer assembly of claim 10 wherein the biasing member is a spring that is disposed between the clip and the cylinder.

20. The door closer assembly of claim 10 wherein the housing includes a retainer that limits movement of the clip away from the cylinder.
